(19) United States
(12) Patent Application Publication
(10) Pub. No.: US 2008/0116184 A1
(43) Pub. Date: May 22, 2008

(54) System and method for remote controlled actuation of laser processing head

(76) Inventors: William G. Fredrick JR., Northville, MI (US); Richard Lee, Plymouth, MI (US); Scott Swartzinski, Plymouth, MI (US); Mike Delbusso, Farmington Hills, MI (US)

Correspondence Address: HARNESS, DICKEY & PIERCE, P.L.C., P.O. BOX 828, BLOOMFIELD HILLS, MI, 48303, US

(21) Appl. No.: 11/998,956

(22) Filed: Dec. 3, 2007

Related U.S. Application Data
(63) Continuation of application No. 10/791,643, filed on Mar. 2, 2004, now abandoned.

(51) Int. Cl. B23K 26/02

(52) U.S. Cl. 219/121.81

(57) ABSTRACT

A control system for remotely actuating a laser processing head includes a laser processing head and an actuation mechanism located remotely from the laser processing head. A translation mechanism is connected between the laser processing head and the actuation mechanism. The translation mechanism translates movement of the actuation mechanism into movement of the laser processing head. The translation mechanism includes a cable control having a first end coupled to the laser processing head and a second end coupled to the actuation mechanism. The laser processing head is slidably coupled to a robot arm. The actuation mechanism imposes relative linear motion of the laser processing head with respect to the robot arm. A height sensing system includes a height sensor for generating a height signal based on a measurement between the laser processing head and a work-piece. A height sensor electronics module is located remotely from the height sensor and receives the height signal.

### CROSS-REFERENCE TO RELATED APPLICATIONS

This application is a continuation of U.S. patent application Ser. No. 10/791,643 filed on Mar. 2, 2004. The disclosure of the above application is incorporated herein by reference.

### FIELD OF THE INVENTION

The present invention relates laser processing heads and more particularly to remote controlled actuation of laser processing heads.

### BACKGROUND OF THE INVENTION

Laser processing has become an increasingly popular method of working a piece of material especially when precise tolerances are necessary. Currently, many laser processing heads incorporate features and devices that help ensure optimal and consistent processing results. One such example is height sensing capability in laser processing heads. Out of necessity, these types of features require mechanical and electrical components that enable them to function properly. These features typically include mechanical slides, motors, encoders and electrical cabling.

These items however are built into the laser processing head in a variety of configurations for a variety of applications. A laser processing head is subjected to harsh working environments due to reflected heat, sparks from the work-piece, debris from the process (including particles, slag, fumes and smoke), dirt and contaminants on the material. Furthermore, the close proximity between the processing head and work-piece may present potential for collision.

The close proximity of these potentially sensitive components to the work-piece places these components at risk and prone to damage and failure. Moreover, by the nature of the desired compactness of a laser processing head, these components are often compromised and limited in size and performance capability.

### SUMMARY OF THE INVENTION

A control system for remotely actuating a laser process head includes a laser process head and an actuation mechanism located remotely from the laser process head. A translation mechanism is connected between the laser process head and the actuation mechanism. The translation mechanism translates movement of the actuation mechanism into movement of the laser process head.

According to other features, the translation mechanism includes a push/pull cable having a first end coupled to the laser processing head and a second end coupled to the actuation mechanism. The laser processing head is slidably coupled to a robot arm. The actuation mechanism imposes relative linear motion of the laser head with respect to the robot arm. A height sensing system includes a height sensor for generating a height signal based on a measurement between the laser head and a work-piece. A height sensor electronics module is located remotely from the height sensor sensing element and generates the height signal.

A remote control system for actuating a tool in one dimension in response to a distance measurement between the tool and a work-piece wherein the distance between the tool and the work-piece is measured by a height sensing system wherein the height sensing system is disposed at least in part in the tool includes a translation mechanism. The translation mechanism includes a first member end and a second member end wherein the first member end is coupled to the tool for actuating the tool in one dimension. The actuation mechanism is coupled to the second member end and actuates the tool. The actuation mechanism is remote to the tool and therefore not connected to the tool. A control system controls the actuation mechanism. The control system is in communication with the height sensing system and senses a distance between the tool and the work-piece. The height sensing system signals the control system to direct the actuation mechanism to actuate the tool in accordance with the distance measured by the height sensing system.

A method for laser processing a work-piece includes providing a laser processing head wherein the laser processing head is coupled to a control system for directing movement of the laser head over the work-piece. The laser processing head comprises a sensor for measuring the distance between the laser processing head and the work-piece. The distance between the sensor and the work-piece is measured. Movement of the actuation mechanism, remotely located from the sensor, is generated based on the measured distance. The movement of the actuation mechanism is translated into linear motion of the laser processing head toward and away from the work-piece.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a system view of the remote actuated laser according to the present teachings;

FIG. 2 is a perspective view of the laser processing head assembly;

FIG. 3 is an exploded view of the laser head assembly of FIG. 2;

FIG. 4 is a partial cutaway view of the actuation mechanism shown communicating with the laser processing head assembly; and

FIG. 5 is a flowchart illustrating steps for remotely actuating the laser processing head assembly.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity the same reference numbers will be used in the drawings to identify similar elements.

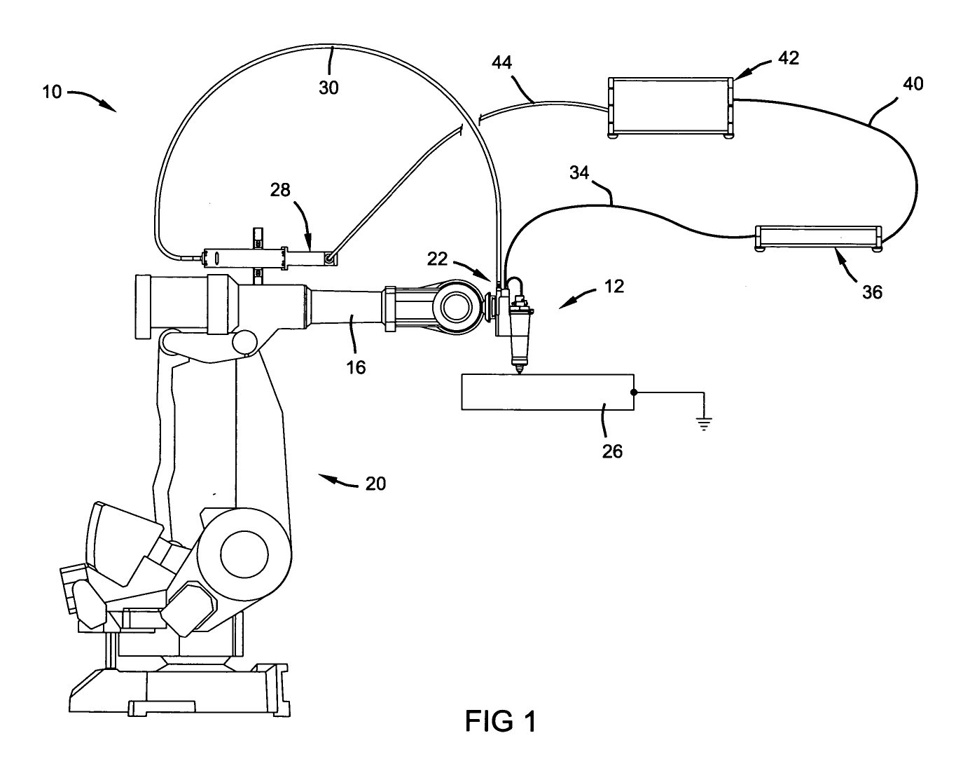

With initial reference to FIG. 1, a remote actuated laser processing system according to the present teachings is shown and identified generally at reference 10. The remote actuated laser processing system 10 includes a laser processing head assembly 12 movably coupled to an arm 16 of a robot 20 through a slide mechanism 22. The laser processing head assembly 12 is configured to cut a work-piece 26 in a predetermined manner. An actuation mechanism 28 is coupled to the laser processing head assembly 12 through a translation mechanism 30. A height signal is communicated through the laser processing head assembly 12 through a first wire 34 to a height sensor electronics module 36 located remotely from the laser processing head assembly 12. The height sensor electronics module 36 communicates a signal through a second wire 40 to a motor drive electronics module 42. The motor drive electronics module 42 is located remotely from the laser head assembly and operates as a control system for controlling movement of the actuation mechanism 28. The motor drive electronics module 42 communicates a signal through a third wire 44 to the actuation mechanism 28. As will be described in greater detail, the actuation mechanism 28 moves the laser processing head assembly 12 in the vertical direction (as viewed from FIG. 1) based on a signal provided by the height sensor electronics module 36 and the motor drive electronics module 42.

The physical location of the sensor electronics 36, the motor drive electronics 42 and the actuation mechanism 28 is away from the harsh environment proximate to the laser processing head assembly 12 thus reducing system vulnerability to debris and damage. Locating the actuation mechanism 28 remotely from the laser head assembly 12 also reduces payload and system wear as a whole. As a result, there is flexibility in choosing an actuation mechanism 28 for a given application.

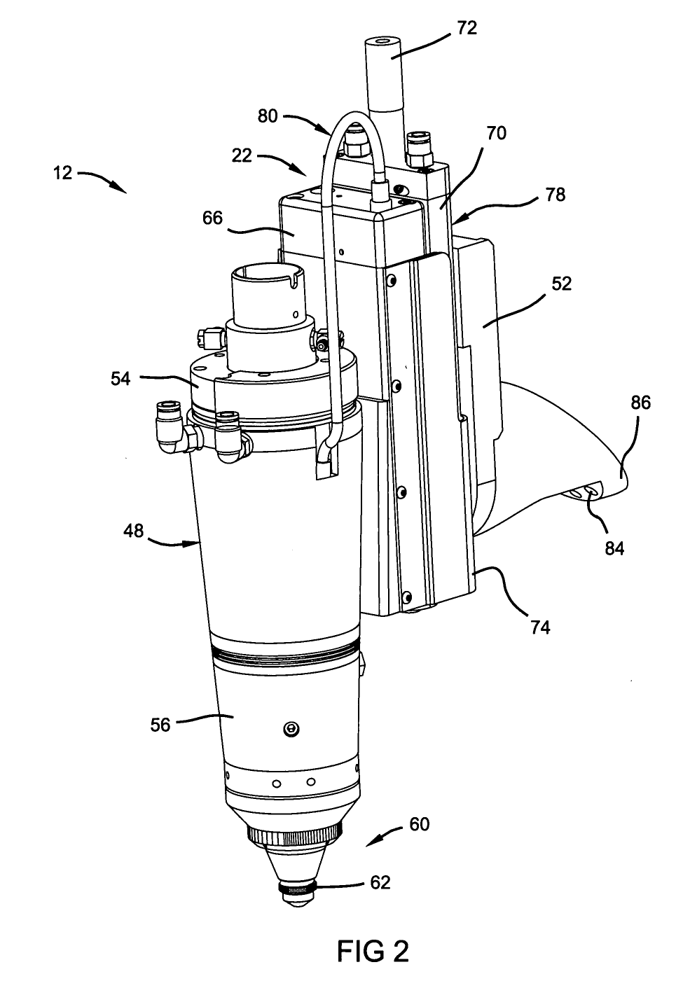

With continued reference to FIG. 1 and further reference to FIG. 2, the laser processing head assembly 12 will be described in greater detail. The laser processing assembly 12 generally comprises a housing 48, the slide mechanism 22 and a mounting flange 52. The housing 48 includes a fiber recollimation optical component 54 for recollimating a laser beam as it exits from a fiber (not shown). The recollimation optical component 54 passes the laser beam to a lens holder 56 having a focusing optic (not specifically shown) therein. A tip assembly 60 is arranged on a distal portion of the laser housing 48 and includes a gas jet tip 62. The gas jet tip 62 serves as a sensor and provides a signal for example, a capacitive signal to the height sensor electronics module 36. The height sensor electronics 36 interprets the signal into the height sense signal. Thus, the height sensor electronics 36 measures the distance between the gas jet tip 62 and the work-piece 26. The tip assembly 60, first wire 34 and the height sensor electronics module 36 define a height sensing system. The height sensing system can advantageously be a capacitive height sense system known to those skilled in the relevant art.

The slide mechanism 22 generally comprises a linear slide 66 slidably coupled to a stationary fixture 70. The translation mechanism 30 mounts to the stationary fixture 70 at a mounting collar 72. An outer housing is coupled to the linear slide 66. The slide mechanism 66 includes a pair of linear bearings for riding along a pair of complementary shafts in the stationary fixture 70 during actuation (not shown). The height signal is communicated through a fourth wire 80 extending between the housing 48 and the linear slide 66. From the linear slide 66, the signal is communicated to the sensor electronics 36 through the first wire 34 (FIG. 1).

The mounting flange 52 is coupled between the robot arm 16 and the stationary fixture 70. The mounting flange 52 is connected to the robot arm 16 with fasteners (not shown) disposed through mounting passages 84 arranged on a lip 86 of the mounting flange 52. The mounting flange 52 does not move with respect to the stationary fixture 70 during operation and is suitably coupled to the stationary fixture 70 by fasteners (not shown). The configuration of the mounting flange 52 is exemplary and may be varied with use of different robot and robot arm arrangements.

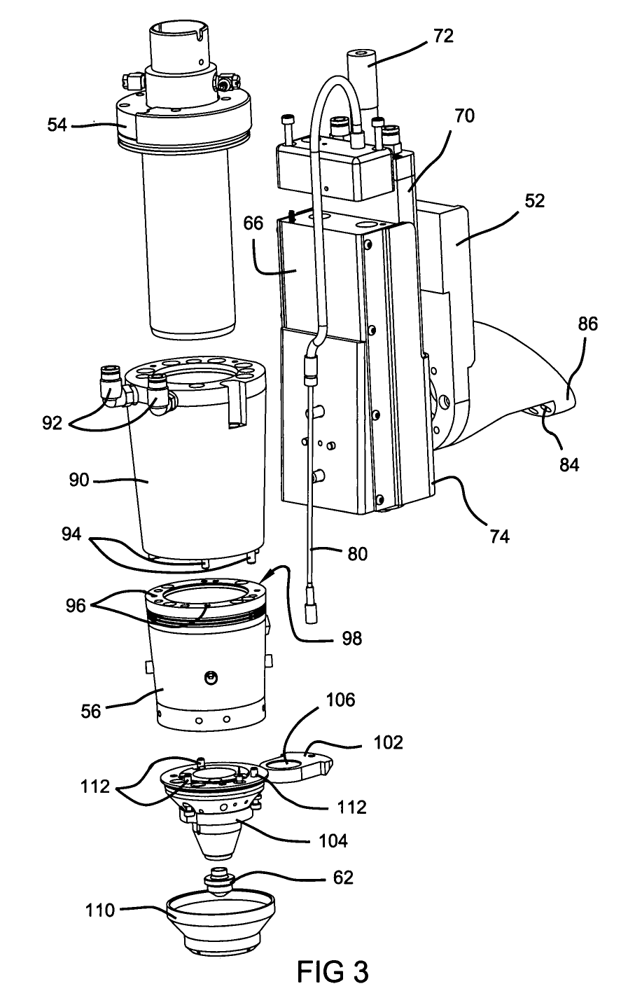

Turning now to FIG. 3, the components associated with the laser housing 48 are shown in exploded view and will be described in greater detail. The fiber recollimation optical component 54 is received by a fiber adapter block 90. The fiber adapter block 90 provides an attachment point at fittings 92 for receiving incoming assist gases required for a processing event. A plurality of locating pins 94 extend on a lower face of the fiber adapter block 90 and are accepted by receiving bores 96 arranged around an upper rim 98 of the lens holder 56.

The tip assembly 60 (FIG. 2) includes a fixed window holder 102 and a tip retainer 104. The fixed window holder 102 includes a window 106 which allows the laser beam to pass through. The fixed window holder 102 also seals a chamber of pressurized gas in the tip retainer 104. The tip retainer 104 operates to deliver the assist gas fed through the fittings 92 coaxially with the laser beam. In addition, the tip assembly 60 is constructed to isolate the capacitive height sensor signal from ground and the remaining laser assembly components. The tip 62 is attached to a distal end of the tip retainer 104. A protective collar 110 shields holds the tip retainer 104 from debris generated during processing. A series of screws 112 are received in complementary bores (not shown) on a lower face of the lens holder 56.

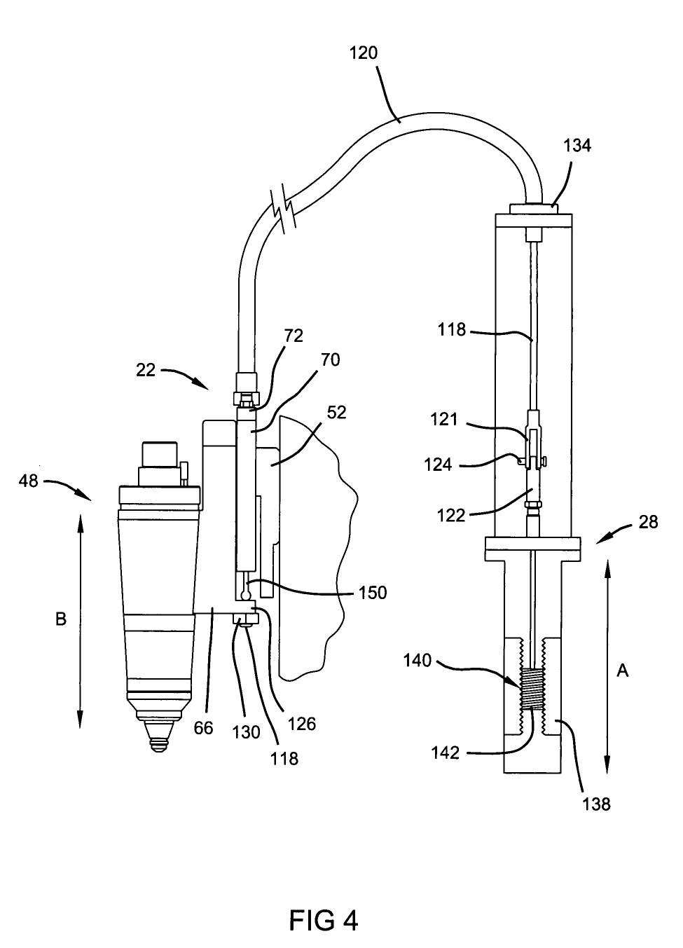

With reference to FIG. 4, the operation of the translation mechanism 30 and the actuation mechanism 28 will be described. The translation mechanism 30 generally includes a flexible cable or cable control 118. The cable control 118 is generally comprised of a flexible inner core having an outer conduit 120. The cable control 118 connects on a first end to an attachment fork 121 which is coupled to an actuating shaft 122 through a pin 124. An opposite end of the cable control 118 is coupled to a lower flange 126 of the linear slide 66 with a fastener 130. The conduit 120 is attached to an end surface 134 of the actuation mechanism 28 on a first end and coupled to the mounting collar 72 of the stationary fixture 70 on an opposite end.

The actuation mechanism 28 is illustrated as a linear actuator in the form of a roller screw mechanism. In general, the actuation mechanism 28 converts rotary torque into linear motion. Those skilled in the art will appreciate that other actuation mechanisms may be employed for actuating the linear slide 66 of the laser processing head assembly 12. For example a guide rail and ball screw arrangement, a belt drive, an electric motor and servo controlled air or hydraulic cylinder configuration and other arrangements may similarly be employed. In addition, while the actuation mechanism 28 is shown located on an upper surface of the robot 20, other locations remotely located from the laser processing head assembly 12 may similarly be used. For example, the actuation mechanism 28 may be located on another portion of the robot arm 16 or fixed to another structure entirely.

The actuation mechanism 28 includes a motor 138 and a roller screw mechanism 140. The roller screw mechanism 140 includes a plurality of threaded rollers 142 assembled in a planetary arrangement around threads arranged on the actuating shaft 122. The motor 138 produces a rotary motion which causes the rollers 142 to advance linearly (arrow A) within the cylindrical structure of the motor 138 thereby converting rotational movement of the motor into linear movement of the actuating shaft 122. Linear movement of the actuating shaft 122 causes the cable control 118 to slidably translate within the conduit 120. Because the cable control 118 is attached to the linear slide 66 at the lower flange 136, movement of the cable control 118 causes resulting movement of the housing 48 (arrow B). The implementation of the translation mechanism 30 allows the actuation mechanism 28 and consequently the motor drive electronics 42 to be physically located at some distance away from the laser processing area. As a result, these components are more protected from the harsh environment of the immediate laser processing area. Another benefit to locating the actuation mechanism 28 in a remote location relative to the laser processing area is that motor and motor drive selection is no longer limited by size or packaging constraints.

For illustrative purposes, the housing 74 (FIG. 3) is shown removed from the linear slide 66 in FIG. 4. An air cylinder 150 cooperates with the slide mechanism 22 to impose a downward force (as viewed from FIG. 4) onto the linear slide 66. More specifically, the air cylinder 150 imposes a force onto the lower flange 126 to move the linear slide 66 downward relative to the stationary fixture 70. The air cylinder 150 provides a constant force on the cable control 118 away from the actuation mechanism 28 to insure that the cable control 118 is always under tension. It is appreciated that other mechanisms may be employed to encourage tension in the cable control 118.

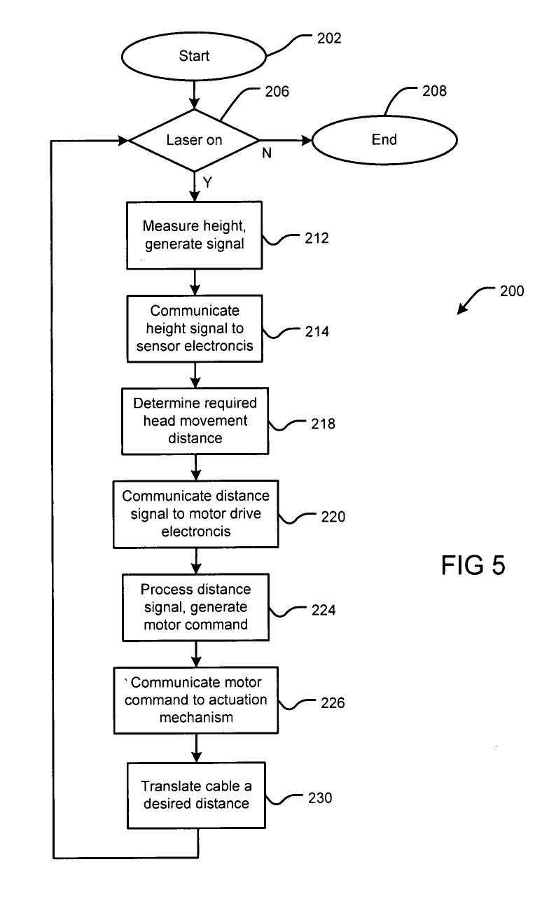

With reference to FIG. 5, steps for remotely actuating the laser processing head assembly are shown generally at 200. Control begins in step 202. In step 206, control determines whether the laser assembly is on. If the system is not on, control ends in step 208. If the system is on, a height measurement is performed by the height sensor electronics module 36 in connection with the tip 62. In step 214, the sensor electronics 36 determines the distance between the tip 62 and the work-piece 26. In step 218, a required laser processing head movement distance is determined. In step 220, the distance signal is communicated through the second wire 40 to the motor drive electronics 42. In step 224, the distance signal is processed and a motor command is generated. In step 226, the motor command is communicated through the third wire 44 to the actuation mechanism 28. In step 230, the cable control 118 is translated a desired distance. Control then loops to step 206.

Those skilled in the art can now appreciate from the foregoing description that the broad teachings of the present invention can be implemented in a variety of forms. For example, the robot 20 is preferably a CNC robot for moving the laser processing head in a predetermined manner but may comprise other robot implementations or machinery. In addition, while the signal communication between the laser processing head assembly, the sensor electronics and the motor drive electronics has been described in relation to transmitting signals through first and second wires, it is contemplated that a wireless signal may be communicated between respective components. In this regard, the sensor electronics and motor drive electronics may similarly be located remotely from the laser head assembly without the requirement of physical attachment by wire. Therefore, while this invention has been described in connection with particular examples thereof, the true scope of the invention should not be so limited since other modifications will become apparent to the skilled practitioner upon a study of the drawings, the specification and the following claims.

What is claimed is:

1. A control system for remotely actuating a laser processing head comprising:
a laser processing head;
a height sensing system, located within said laser processing head;
an actuation mechanism located remotely from said laser processing head; and
a translation mechanism connected between said laser processing head and said actuation mechanism, said translation mechanism translating movement of said actuation mechanism into movement of said laser processing head in response to signals from the height sensing system.

2. The control system of claim 1 wherein said translation mechanism comprises:
a cable control having a first end coupled to said laser processing head and a second end coupled to said actuation mechanism.

3. The control system of claim 2 wherein said laser processing head is slidably coupled to a robot arm, said actuation mechanism imposing relative linear motion of said laser processing head with respect to said robot arm.

4. The control system of claim 1, further comprising an actuator control system for controlling said actuation mechanism.

5. The control system of claim 1, wherein said height sensing system comprises:
a height sensor for generating a height signal based on a measurement between said laser processing head and a work-piece: and
a height sensor electronics module located remotely from said height sensor and receiving said height signal.

6. The control system of claim 5, wherein said height sensing system further includes a wire communicating said height signal between said height sensor and said height sensor electronics module.

7. The control system of claim 5 wherein said actuator control system is in communication with said height sensing system wherein said height sensor signals said actuator control system to direct said actuation mechanism to actuate said laser processing head based on said height signal generated by said height sensing system.

8. The control system of claim 2 wherein said second end of said cable control is coupled to a roller screw mechanism of said actuation mechanism remotely positioned from said laser processing head.

9. The control system of claim 2 wherein said cable is biased in a direction away from said actuation mechanism.

10. The control system of claim 2 wherein said cable is biased away from said actuation mechanism by an air cylinder.

11. A laser processing control system comprising:
a laser processing head;
a height sensing system coupled to the laser processing head;
a screw drive mechanism located remote from the laser processing head; and
a flexible drive mechanism coupled to the screw drive mechanism, said drive mechanism coupled to and reactive to said height sensing system.

12. The system according to claim 11 wherein said flexible drive mechanism comprises a flexible linearly actuatable cable.

13. The system according to claim 11 further comprising a motor driven robotic arm coupled to the laser processing head.

14. The system according to claim 11 wherein the flexible drive mechanism is an actuatable control cable having a first end coupled to the laser processing head and a second end operatively coupled to the screw mechanism.

15. The system according to claim 11 further comprising a gas source coupled to the laser processing head.

16. The system according to claim 11 wherein the laser processing head comprises laser optics.

17. The system according to claim 11 wherein the flexible drive mechanism is biased away from said screw mechanism.

18. The system according to claim 17 wherein said flexible drive is biased away from the screw mechanism by an air cylinder.

19. The system according to claim 11 wherein the laser processing head is slidably coupled to a robot arm, said screw drive mechanism imposing relative linear motion of said laser processing head with respect to the robot arm.

20. The system according to claim 11 wherein the height sensing mechanism is in the laser processing head.
